(19) United States
(12) Patent Application Publication
(10) Pub. No.: US 2010/0181535 A1
(43) Pub. Date: Jul. 22, 2010

(54) THE PHOTOSTABILITY AND/OR CONTROL OF THE FLUORESCENCE INTENSITY OF FLUORESCENT DYES

(75) Inventors: Philip Tinnefeld, Bielefeld (DE); Markus Sauer, Heidelberg (DE)

Correspondence Address: OCCHIUTI ROHLICEK & TSAO, LLP, 10 FAWCETT STREET, CAMBRIDGE, MA, 02138, US

(73) Assignee: PicoQuant GmbH, Berlin (DE)

(21) Appl. No.: 12/666,980

(22) PCT Filed: Jun. 27, 2008
(86) PCT No.: PCT/EP2008/058287

§ 371 Date: Dec. 28, 2009

(30) Foreign Application Priority Data
Jun. 29, 2007 (DE) 10 2007 030 403.1

(51) Int. Cl. C09K 11/06

(52) U.S. Cl. 252/301.16

(57) ABSTRACT

The present invention relates to a process for improving the photostability and/or control of the fluorescence intensity of a fluorescent dye wherein a fluorescent dye is admixed with a redox buffer comprising at least one reducing agent and/or at least one oxidizing agent and/or at least one reducing-oxidizing agent, and also to a fluorescent dye composition comprising a fluorescent dye and a redox buffer comprising at least one reducing agent and at least one oxidizing agent or at least one reducing-oxidizing agent.

The invention relates to the area of photostabilization and fluorescence intensity of fluorescent dyes. In addition the invention relates to a process for improving the photostability and/or control of the fluorescence intensity of fluorescent dyes as well as a photostabilized fluorescent dye composition.

Fluorescence is a form of luminescence which rapidly ends after the end of the radiation. Fluorescent dyes are organic dyes which absorb ultraviolet radiation or visible light and emit said ultraviolet radiation or visible light again within a few nanoseconds practically completely in the form of light (emission). The low-energy fluorescent light can be registered with the help of detectors. Fluorescent dyes are employed in numerous areas of technology, for example in lighting fixtures or as optical intensifier in dye lasers or in fluorescence microscopy all the way to observation of free molecules by means of single molecule fluorescence spectroscopy, in particular however in numerous analytical and diagnostic methods in biochemistry and medicine, for example in the automatic sequencing of DNA, for the detection of DNA and protein chips, as fluorescence markers of biomolecules or as fluorescent probes for specific marking in immunology.

One factor limiting the applicability of fluorescent dyes is in particular the photostability of the dye molecules. Through light-induced chemical change fluorescent dyes lose the ability to fluoresce. This process is as referred to as photobleaching.

In particular under conditions of strong illumination such as in the case of fluorescence microscopy, in which case the dye molecules are rapidly bleached, the photostability of the dye molecules is significantly decreased. The process of photobleaching is ordinarily an irreversible process, as a result of which fluorescent dyes only possess a low fastness and are rapidly consumed. Therefore there is a need for means and processes for improving the photostability of fluorescent dyes.

It is known to use different substances for the photostabilization of fluorescent dyes, such as oxygen-depleting systems or conjugates with organic macromolecules. For example the publication WO 2006/079091 also discloses the use of metal nanoparticles for the stabilization of fluorescent dyes.

Disadvantageous in the case of many known substances however is the fact that in the case of many fluorescent dyes these known substances lead to a reduced photostability. In particular the achievable photostability is in many cases unsatisfactory for especially sensitive applications, for example for dye lasers.

One further disadvantage of many processes of fluorescent spectroscopy is their insufficient optical resolution. Thus microscopy is subject to the diffraction limit, which lies about in the range of 250 nm in the case of conventional microscopes, as a result of which smaller structures cannot be resolved. The publication WO 2006/127692 discloses one possibility for circumventing this limitation. Said publication proposes using photoswitchable fluorophores. In this connection fluorescent molecules are purposefully excited to fluorescence, their fluorescence imaging function is individually evaluated and subsequently processed to a high-resolution image. One requirement for the applicability of the proposed process however lies in the availability of fluorescent dyes which are continuously present in a fluorescing or non-fluorescing state. Only a few photoactivable or photoswitchable fluorophores are known here. Furthermore, frequently the switching speed is restricted so that the exposure time absorption period is long. Finally the on and off switching rate cannot be sufficiently controlled monitored.

Further disadvantageous in the case of the process proposed in the publication WO 2006/127692 is the fact that this achieves a fluorescing or non-fluorescing state by the irradiation of different wavelengths, as a result of which the process can only be used using complex fluorescence devices.

Therefore it was the object of the invention to overcome at least one disadvantage of the state of the art and to make available means and resources for the improvement of the photostability and/or control of the fluorescence intensity of fluorescent dyes.

In accordance with the invention this task is solved by a process for improving the photostability and/or control of the fluorescence intensity of a fluorescent dye, wherein a fluorescent dye is admixed with a redox buffer comprising at least one reducing agent and/or at least one oxidizing agent and/or at least one reducing-oxidizing agent.

A further subject matter of the invention relates to a photostabilized fluorescent dye composition comprising at least one reducing agent and at least one oxidation agent or at least one reducing-oxidizing agent.

A further subject matter is a kit suitable for the carrying out of the method.

Additional advantageous embodiments of the invention arise from the dependent claims.

For the purpose of this invention, unless otherwise specified, the term “fluorescent dye” is to be understood as both dye molecules as well as fluorescent dye complexes or fluorescent dye conjugates, for example which can be formed through covalent or non-covalent interaction, conjugation or other types of bonding of a fluorescent dye to inorganic or organic molecules, in particular to biomolecules like proteins, biotin or nucleic acids.

For the purpose of this invention the term “photostability” is the mean number of cycles of radiation absorption and fluorescence emission of the fluorescent dye molecules until the fluorescent dye loses its fluorescence. An improvement of the photostability is in particular an increase in the photostability. An increase of the photostability means in this respect an extension of the fluorescent period of the fluorescent dye molecule.

For the purpose of this invention “reducing-oxidizing agents” are substances which can act both as reducing agents as well as also oxidizing agents, for example ubiquinone or cytochrome.

For the purpose of this invention “redox buffers” are substances or mixtures comprising reducing agents, oxidizing agents and/or reducing-oxidizing agents which in an electron transfer reaction in particular of a photo-induced electron transfer reaction can react with a fluorescent dye and can transfer electrons to a fluorescent dye or receive them from a fluorescent dye.

Preferably a redox buffer comprises a reducing agent and an oxidizing agent, wherein provision can be made that the ratio of reducing agent to oxidizing agent is appreciably shifted to one side or the amount of reducing agent or oxidizing agent is zero.

Preferred redox buffers comprise at least one reducing agent and at least one oxidizing agent or at least one reducing-oxidizing agent. Further preferred redox buffers comprise at least one reducing agent, and/or at least one oxidizing agent and/or at least one reducing-oxidizing agent.

Processes for improving the photostability and/or fluorescence intensity of a fluorescent dye wherein a fluorescent dye is admixed with a redox buffer comprising at least one reducing agent and at least one oxidizing agent or at least one reducing-oxidizing agent are preferred.

Surprisingly it has been found that redox buffers comprising reducing agents and oxidizing agents or a reducing-oxidizing agent can considerably increase the photostability of fluorescent dyes.

In particular it has been found surprisingly that inventive redox buffers in particular those comprising at least one reducing agent and at least one oxidizing agent or at least one reducing-oxidizing agent can cause a photostabilization of a broad number of fluorescent dye classes. This is in particular surprising since known substances ordinarily can cause a photostabilization in the case of few fluorescent dye classes, in the case of other classes on the other hand can cause a reduction of the stability. Of particular advantage in the case of the inventive redox buffers in particular those comprising at least one reducing agent and at least one oxidizing agent or at least one reducing-oxidizing agent is the fact that this universally or practically universally applicable for known classes of fluorescent dyes and can cause an improvement of the photostability and/or fluorescence intensity of the fluorescent dyes.

Additionally it was possible to ascertain that inventive redox buffers in particular those comprising one reducing agent and at least one oxidizing agent or at least one reducing-oxidizing agent can cause a photostabilization of fluorescent dyes which was preferably increased by a factor of 1.2 to 5, preferably by a factor of 2 to 5, preferably by a factor of 4 to 5 compared to otherwise identical systems without redox buffers or in comparison to a use of known reducing agents in the case of otherwise identical systems. For example through measurements on free molecules it was able to be ascertained that on the average of at least 20 measurements an improvement of the photostability by a factor of 4 to 5 was able to be achieved.

This means a great advantage, since a corresponding extension of the measuring times is made possible. This is of great significance in particular in the diagnostics and other medical application of fluorescent dyes.

In addition it was surprisingly that redox buffers comprising reducing agents and oxidizing agents can likewise significantly increase the intensity of the fluorescence of fluorescent dyes. For example it was able to be ascertained that in the case of free molecule measurements an increase of the luminous intensity of up to 25% was able to be achieved.

This is in particular surprising since from an improvement of the photostability, that is from an increase of the mean number of fluorescence cycles per fluorescent dye molecule it is not possible to infer an improved quantum yield of emitted fluorescent radiation per radiation radiated by the same reagent.

A further significant advantage of the use of a redox buffer lies in the fact that intensity fluctuations, the “blinking”, can be reduced. This is in particular of advantage in free molecule measurements since these require the least possible interrupted fluorescence of the molecule.

A particular advantage of the redox buffers lies in the fact that these can depopulate or delete triplet states, but on the other hand do not adversely influence the singlet states, from which the fluorescent radiation is emitted.

In preferred processes a fluorescent dye is admixed with a redox buffer comprising one reducing agent, and/or at least one oxidizing agent and/or at least one reducing-oxidizing agent.

A further preferred embodiment of a process for increasing the photostability and/or control of the fluorescence intensity relates to a process for setting the fluorescent state of a fluorescent dye wherein a fluorescent dye is admixed with a redox buffer comprising one reducing agent, and/or at least one oxidizing agent and/or at least one reducing-oxidizing agent.

For the purpose of this invention the term “fluorescent state of a fluorescent dye” is to be understood as the fact that fluorescent dyes can be present in a fluorescing or “On” state or in a non-fluorescing state, a dark or “Off” state. Fluorescent dyes can change between these states.

One further advantage of using a redox buffer lies in the fact that intensity fluctuations can be purposefully chronologically modulated through the use of a redox buffer.

Thus it was further found surprisingly that redox buffers comprising at least one reducing agent, and/or at least one oxidizing agent and/or at least one reducing-oxidizing agent make it possible to selectively control the time fluctuations of the fluorescence intensity of a fluorescent dye.

In particular it was surprisingly found that a redox buffer comprising at least one reducing agent or at least one oxidizing agent is suitable for extending the non-fluorescing state, the dark or “Off” state of a fluorescent dye.

For example it was able to be ascertained that a redox buffer comprising at least one reducing agent can cause the reversible non-fluorescing state of a fluorescent dye to be able to stop in the range of 30 ms to 200 ms. Additionally it was possible to establish that a redox buffer comprising at least one oxidizing agent can cause the reversible non-fluorescing state of a fluorescent dye to be extended, for example up to 100 ms.

This signifies a great advantage, since a corresponding extension of the non-fluorescing state makes it possible to use the fluorescent dye in processes for increasing the optical resolution in fluorescence microscopy. An improvement of the optical limit of resolution is of great significance, in particular in structural biology, biological imaging, diagnostics and other medical applications of fluorescent dyes.

The purposeful setting of the time fluctuations of the fluorescence intensity of a fluorescent dye through the admixture of redox buffers makes the selective marking of specified molecules in living cells with fluorescent dyes possible, as well as a significant improvement of the optical resolution of imaging fluorescence microscopy processes with comparably little technical expenditure. In particular a plurality of spectrally differing dyes are suitable for these applications, said spectrally differing dyes being already commercially widespread and requiring no further modification.

Another significant advantage of using a redox buffer comprising at least one reducing agent and at least one oxidizing agent lies in the fact that by setting the ratio between reducing agent and oxidizing agent, for example by the admixture of oxidizing agents to a redox buffer containing predominantly reducing agents, the time period during which the fluorescent dye remains in the non-fluorescing state can be regulated.

This makes possible for example to adapt the continuance of a fluorescent dye in the non-fluorescent state to different processes of fluorescence measurement. For example, as a result of this it is made possible to increase the resolution in the saturation microscopy (DSOM Dynamic Saturation Optical Microscopy), which requires the rapid changing between the fluorescing and non-fluorescing state of the fluorescent dye.

In addition by setting the ratio between reducing agent and oxidizing agent the duration of the non-fluorescing “Off” state of a fluorescent dye can be set in the range of nanoseconds to the millisecond range. Thus for example through the content in oxidizing agents of a redox buffer containing predominantly reducing agents a setting of the duration of the “Off” state can be brought about. Likewise through the content in reducing agents of a redox buffer containing predominantly oxidizing agents a setting of the duration of the “Off” state can be brought about.

For example the duration of the non-fluorescing “Off” state of a fluorescent dye can lie in the range of ≧10 ns to ≦200 ms, preferably in the range of ≧100 ns to ≦100 ms, preferably in the range of ≧1 ms to ≦100 ms, especially preferably in the range of 5 ms to ≦20 ms.

The duration of the fluorescing “On” state of the fluorescent dye can for one thing be controlled by the laser power, and can for example amount to circa 5 ms at circa 100 W/cm². For example increasing the laser power can cause a corresponding anti-proportional shortening of the duration of the fluorescing “On” state of the fluorescent dye. In the process preferably the number of the emitted photons during an “On” state does not change approximately. The duration of the “On” state can in addition be achieved by an increased admixture of oxidizing agent or reducing agent by depopulating at concentrations≧10 μmol/l to ≦1 mol/l, preferably ≧100 μmol/l to ≦50 mmol/l, also singlet states through photo-induced electron transfer. In the case of this type of control of the “On” state the number of emitted photons during an “On” state can correspondingly reduce itself.

Furthermore the number of the emitted photons during an “On” state can be influenced by the concentration of the reducing and/or oxidizing agent. For example an increased concentration of the reducing and/or oxidizing agent can cause a reduction in the number of the photons emitted during an “On” state.

In preferred embodiments the fluorescent dye is dissolved in a solvent. Preferred solvents are selected from the group comprising water, alcohols, preferably selected from the group comprising methanol, ethanol, isopropanol, n-propanol, n-butanol, tert-butanol and/or phenol, dimethyl sulfoxide (DMSO), glycerol, organic solvents and/or mixtures of them.

Preferred solvents are selected from the group comprising water, methanol, ethanol, isopropanol and/or n-propanol.

Further preferred solvents are buffer solutions, preferably selected from the group comprising phosphate-buffered salt solution (PBS) and/or BBS (balanced salt solution).

Yet another advantage can arise from the fact that likewise the fastness or shelf life of fluorescent dyes in solution can be increased, in particular in glass containers and in particular in the case of existing incident light radiation, i.e. conventional white light fluorescent lamps, or natural daylight. For example the fastness of fluorescent dye solution containing a redox buffer comprising at least one reducing agent and at least one oxidizing agent or a reducing-oxidizing agent can be increased by 10% to 20% compared to the otherwise identical fluorescent dye solution without redox buffers.

Preferably oxidizing agents and reducing agents of the redox buffer are selected in such a way that the mixture of oxidizing agents and reducing agents forms a redox buffer. Preferably the oxidizing agent and the reducing agent do not lose their effect as a result of the fact that they react with compounds which no longer exhibit a reducing or oxidizing effect. However, it can be preferred that the oxidizing agent and the reducing agent can react with each other, for example can reduce or oxidize each other.

Preferred are combinations of a gentle or weak oxidizing agent in particular of an organic oxidizing agent and a gentle or weak reducing agent in particular of an organic reducing agent.

In preferred embodiments provision is made that the redox buffer comprises at least one reducing agent and at least one oxidizing agent or at least one reducing-oxidizing agent. The redox buffer can comprise one or more reducing agents and one or more oxidizing agents or one or more reducing-oxidizing agents. For example the redox buffer can comprise mixtures of several reducing agents and/or mixtures of several oxidizing agents. It is preferred that the redox buffer comprises one reducing agent and one oxidizing agent or one reducing-oxidizing agent.

In further preferred embodiments, in particular in processes for setting the fluorescence state of a fluorescent dye provision is made that the redox buffer comprises at least one reducing agent, and/or at least one oxidizing agent and/or at least one reducing-oxidizing agent.

For the purpose of this invention the term “oxidizing agent” is to be understood as substances which on the basis of their redox potential can react with the fluorescent dye in a photo-induced electron transfer. That means that the electronically excited fluorescent dye emits an electron through a collision with the oxidizing agent and a radical cation is formed. The redox potential necessary for this purpose depends on the redox potential of the fluorescent dye, the transition energy of the fluorescent dye and the environment, i.e. from the solution and the temperature.

The redox potential of a suitable oxidizing agent lies in the case of pH 7 measured against normal hydrogen electrode (NHE) in acetonitrile in the range of ≧−1 V to ≦0.2 V, preferably in the range of ≧−600 mV to ≦100 mV, preferably in the range of ≧−250 mV to ≦−200 mV.

The person skilled in the art can easily determine which oxidizing agent results in the best increase in the photostability and/or fluorescence intensity for a given fluorescent dye through a few routine tests. Likewise the person skilled in the art can easily determine which oxidizing agent results in the best residence time for a given fluorescent dye in processes for setting the fluorescence state of a fluorescent dye.

Preferred oxidizing agents are bipyridinium salts, their derivatives and/or nitroaromatics.

Preferred bipyridinium salts are selected from the group comprising 2,2′-Bipyridinium salts and/or 4,4′-Bipyridinium salts, preferably N,N′-Dialkyl-2,2′-Bipyridinium salts and/or N,N′-Dialkyl-4,4′-Bipyridinium salts, wherein the alkyl groups preferably are identical or different linear or branched C1-C20 alkyl groups, preferably selected from the group comprising methyl, ethyl, propyl, isopropyl, butyl, tert-butyl, pentyl, hexyl and/or heptyl.

Especially preferred bipyridinium salts are viologens, N,N′-Dialkyl-4,4′-Bipyridinium salts, in particular methyl viologen, 1,1′-Dimethyl-4,4′-bipyridinium and heptyl viologen, 1,1′ diheptyl-4,4′-Bipyridinium.

Preferred salts are chlorides.

Water soluble oxide agents are preferable. Especially preferably oxidizing agents are selected from the group comprising bipyridinium salts, preferably violegens, in particular methyl viologens (1,1′-Dimethyl-4,4′-Bipyridinium), nitroaromatics, substituted nitroaromatics, in particular carboxylic acid substituted nitroaromatics or sulfonic acid-substituted nitroaromatics, benzoquinones, substituted benzoquinones, in particular chlorine substituted and/or cyan substituted benzoquinones, in particular dichlorobenzoquinone, tetrachlorobenzoquinone, tetracyanobenzoquinone and/or mixtures thereof.

Suitable aromatics are compounds in which one or more, preferably one or two nitro groups are bonded to one carbon atom each in an aromatic ring. The nitroaromatics are preferably phenyl- or toluene compounds. The aromatic ring, preferably a phenyl remnant, is along with the nitro group or groups preferably substituted with sulfonic acid, carboxylic acid, halogen in particular chlorine and/or CN groups.

Additionally preferred are sulfonic acid, carboxylic acid, nitro, chlorine and/or cyan substituted derivatives of the nitroaromatics, in particular of nitrobenzene. Especially preferred nitroaromatics are nitrobenzene, carboxylic substituted nitroaromatics or sulfonic substituted nitroaromatics.

Suitable nitroaromatics are for example selected form the group comprising nitrobenzene, Di-nitrobenzene, in particular o-Dinitrobenzene and m-Di-Nitrobenzene, nitrophenol, Di-Nitrophenol, Nitrotoluenes such as m-Nitrotoluene, o-Nitrotoluene and p-Nitrotoluene and/or Di-Nitrotoluenes, Nitrobenzene is especially preferred.

Suitable carboxylic substituted nitroaromatics are for example selected from the group comprising nitrobenzene acids such as m-Nitrobenzoic acid, p-Nitrobenzoic acid and o-Nitrobenzoic acid, nitrobenzoicdicarboxylic acids such as 4-Nitro-1,2-benzenedicarboxylic acid, 3-Nitro-1,2-benzenedicarboxylic acid, 4-Nitro-1,3-benzenedicarboxylic acid and/or 5-Nitro-1,3-benzenedicarboxylic acid.

Additionally suitable are carboxylic acid and chlorine substituted nitroaromatics, for example selected from the group comprising chloronitrobenzene acid and/or dichloronitrobenzene acid.

Suitable sulfonic acid substituted nitroaromatics are for example selected from the group comprising nitrobenzenesulfonic acids and/or nitrotoluenesulfonic acids such as 4-nitrotoluene-2-sulfonic acid.

Additionally suitable are cyan-substituted nitroaromatics and/or chlorine substituted nitroaromatics, for example selected from the group comprising chlorine-nitrobenzenes, such as m-Chloronitrobenzene, o-Chloronitrobenzene and p-Chloronitrobenzene, chlorodinitrobenzenes such as Chlorine-2,4-dinitrobenzene, dichloronitrobenzenes, dichlorodinitrobenzenes, chlorine substituted nitrophenols and/or chlorine substituted nitrotoluenes.

Preferred benzoquinones are selected from the group comprising p-Benzoquinone, nitro-substituted benzoquinones, chlorine substituted benzoquinones, sulfonic acid, carboxylic acid and/or cyan substituted benzoquinones, for example selected from the group comprising dichlorobenzoquinone, tetrachlorobenzoquinone, dicyanobenzoquinone and/or tetracyanobenzoquinone.

Additional suitable oxidizing agents are selected from the group comprising phenols, indophenols, hydroquinones, catechols, chromane, dihydrobenzofurane, dihydroxinaphthalene and/or naphthols as well as their sulfonic acid, carboxylic acid, nitro, chlorine and/or cyan substituted derivatives.

Very especially preferred oxidizing agents are selected from the group comprising viologens, in particular methylviologens and/or substituted nitroaromatics, such as carboxylic acid substituted nitroaromatics or sulfonic acid substituted nitroaromatics.

One advantage of oxidizing agents selected from the group comprising bipyridinium salts, preferably viologens, in particular methylviologens (1,1′-Dimethyl-4,4′-bipyridinium), nitroaromatics, in particular carboxylic acid substituted nitroaromatics or sulfonic acid substituted nitroaromatics, preferably nitrobenzene, benzoquinone, in particular dichlorobenzoquinone, tetrachlorobenzoquinone, tetracyanobenzoquinone or p-benzoquinone lies in the fact that these can bring about a good photostabilization of the fluorescent dyes. In particular methylviologen can cause an especially good photostabilization.

For the purpose of this invention the term “reducing agent” is to be understood as substances which can transfer an electron to a fluorescent dye molecule, in particular y collision in an electronically excited state, i.e. reducing the fluorescent dye while forming a dye radical anion. The redox potential required for this purpose depends on the potential of the fluorescent dye, the transition energy of the fluorescent dye and the environment, i.e. of the solvent and of the temperature.

The redox potential of a suitable reducing agent lies in the case of pH 7 measured against normal hydrogen electrode (NHE) in acetonitrile in the range of ≧0.1V to ≦2 V, preferably in the range of ≧500 mV to ≦800 mV, preferably in the range of ≧450 mV to ≦750 mV.

The person skilled in the art can easily determine which reducing agent results in the best increase in the photostability and/or fluorescence intensity for a given fluorescent dye through a few routine tests. Likewise the person skilled in the art can easily determine which reducing agent results in the best residence time for a given fluorescent dye in processes for setting the fluorescence state of a fluorescent dye.

Suitable reducing agents are selected from the group comprising aliphatic and aromatic primary, secondary and tertiary Amines, mono- and di-Naphthylamines, in particular β-Naphthylamine, Phenylamine, Diphenylamine, p-Phenylendiamine, Hydroxylamine, Hydroxylamine derivatives, dihydroquinoline derivatives, piperidine derivatives and/or pyrrolidine derivatives.

Suitable reducing agents are additionally selected from the group comprising Thiophenols, Thionaphthols, Phenolsulfide, uric acid (urate), urea, Bilirubin, ascorbic acid and/or Flavine. Further suitable reducing agents are cyclo-Octatetraene (5,6-Bis-Acetoxymethyl-Cycloocta, COT) and 1,4-diaza-bicyclo-(2,2,2)-octane (DABCO).

Preferred reducing agents are selected from the group comprising 6-Hydroxy-2,5,7,8-tetramethylchromane-2-carboxylic acid, ascorbic acid, β-mercaptoethanol, β-mercaptoethylamine, Dithiothreitol, NaBH₃CN, n-Propyl-Gallate and/or mixtures thereof. One especially preferred reducing agent is 6-Hydroxy-2,5,7,8-tetramethylchromane-2-carboxylic acid (Trolox®).

Preferred redox buffers comprise as a reducing agent Trolox® and as an oxidizing agent methylviologen, as a reducing agent NaBH₃CN and as an oxidizing agent tetrachlorobenzoquinone, as a reducing agent ascorbic acid and as an oxidizing agent p-benzoquinone, and/or as a reducing agent diphenylamine and as an oxidizing agent dinitrobenzene.

Especially preferred redox buffers comprise as a reducing agent ascorbic acid and as an oxidizing agent methylviologen. Of advantage in the case of the use of a redox buffer comprising as a reducing agent ascorbic acid and as an oxidizing agent methylviologen is being able to reduce intensity fluctuations already at low concentrations. Additionally of advantage is the fact that a considerable improvement of the photostability of fluorescent dyes can be achieved. Additionally of advantage is the fact that ascorbic acid and methylviologen both exhibit a good water solubility, as a result of which the use in aqueous systems is facilitated.

Additional suitable redox buffer systems are selected from the group comprising Dehydroascorbic acid/ascorbic acid, cystine, cysteine, dithioerythritol, C₄H₈O₂S₂/C₄H₁₀O₂S₂, Dithionite SO₃²⁻/S₂O₄²⁻, dithiothreitol C₄H₈O₂S₂/C₄H₁₀O₂S₂, Fe²⁺/Fe³⁺, nitrate/nitrite, ferricanide/ferrocyanide, cytochrome a (Fe²⁺/Fe³⁺), cytochrome c (Fe²⁺/Fe³⁺) cytochrome b2 (Fe²⁺/Fe³⁺), ubiquinone (ox/red), fumarate/succinate, methylene blue (ox/red), pyruvate and ammonium/alanine, alpha oxoglutarate and ammonium/glutamate, oxalacetate/malate, pyruvate/lactate, acetaldehyde/ethanol, riboflavin (ox/red), glutathione (ox/red), acetoacetate/beta-Hydroxybutyrate, lipoic acid/dihydrolipoic acid, NAD⁺/NADH, pyruvate/malate, ferredoxin (ox/red) and/or succinate/alpha-Oxoglutarate.

In preferred embodiments the ratio of reducing agent to oxidizing agent lies in the range of ≧1:3 to ≦10:1, preferably in the range of ≧1:2 to ≦4:1, preferably in the range of ≧1:1 to ≦2:1. In additional preferred embodiments the ratio of reducing agent to oxidizing agent lies in the range of ≧1:3 to ≦5:1, preferably in the range of ≧1:2 to ≦3:1, preferably in the range from ≧1.5:1 to ≦2:1.

In preferred embodiments a surplus of the reducing agent is present. Preferably the ratio of reducing agent to oxidizing agent can lie in the range of ≧2:1 to ≦5:1, preferably in the range of ≧3:1 to ≧4:1. In particular for fluorescent dyes selected from the group comprising cyanine, rhodamine, oxazine, fluorescein and/or carborhodamine a surplus, in particular a slight surplus of the reducing agent to the oxidizing agent in the range of ≧2:1 to ≦3:1 can lead to an increase of the photostability of the fluorescent dye and/or an increase of the intensity of the fluorescent radiation.

It can also be preferred that the oxidizing agent be present in surplus, for example the ratio of reducing agent to oxidizing agent can lie in the range of ≧1:3 to ≦1:1, preferably in the range of ≧1:1.5 to ≦1:2. For example, a surplus, in particular a slight surplus of the oxidizing agent, for example a ratio of reducing agent to oxidizing agent in the range of ≧1:1 to ≦1:2 can lead to an increase of the photostability of the fluorescent dye and/or an increase of the intensity of the fluorescent radiation.

In further preferred embodiments in particular in processes for setting the fluorescent state of a fluorescent dye the ratio of reducing agent to oxidizing agent can be appreciably shifted to one side or the amount of reducing agent or oxidizing agent can be zero. Fore example the ratio of reducing agent to oxidizing agent can lie in the range of ≧1000:0 to ≦0:1000, preferably in the range of ≧1000:0 to ≦1:100, preferably in the range of ≧100:1 to ≦0:1000, additionally preferably in the range of ≧100:1 to ≦1:100, especially preferably in the range of ≧10:1 to ≦1:10.

The concentration of the reducing agent can vary in wide ranges. In preferred embodiments the concentration of the reducing agent lies in the range of ≧1 μM mM to ≦100 mM, preferably in the range of ≧0.1 mM to 10≦mM, preferably in the range of ≧0.5 mM to 5≦mM, especially preferably in the range of ≧1 mM to 3≦mM. The concentration of the reducing agent Trolox® lies preferably in the range of ≧0.5 mM to ≦3 mM, preferably in the range of ≧1.8 mM to ≦2.5 mM.

The concentration of the oxidizing agent can vary in wide ranges. In preferred embodiments the concentration of the oxidizing agent lies in the range of ≧1 μM to ≦200 mM, preferably in the range of ≧0.1 mM to 10≦mM, preferably in the range of ≧1 mM to 10≦mM, especially preferably in the range of ≧1 mM to 3≦mM.

The concentration of the oxidizing agent methylviologen lies preferably in the range of ≧0.2 mM to ≦3 mM, preferably in the range of ≧0.5 mM to ≦1 mM.

The concentration of the redox buffer comprising at least one reducing agent and at least one oxidizing agent or a reducing-oxidizing agent lies for example in an aqueous solution preferably in the range of ≧0.2 mM to ≦10 mM, preferably in the range of ≧0.5 mM to ≦5 mM, especially preferably in the range of ≧1 mM to ≦3 mM.

In additional embodiments the concentration of a redox buffer comprising at least one reducing agent and at least one oxidizing agent or a reducing-oxidizing agent lies for example in an aqueous solution preferably in the range of ≧0 mM to ≦100 mM, preferably in the range of ≧0.01 mM to ≦50 mM, additionally preferably in the range of ≧0.1 mM to ≦10 mM, also preferably in the range of ≧0.2 mM to ≦5 mM, especially preferably in the range of ≧0.5 mM to ≦2 mM.

Suitable reducing agents and/or substances deleting the triplet state can additionally be selected from the group comprising carotenoids, in particular tocopherols, thiols, in particular gluthathione, cysteine, N-Acety-Cysteine, Dihydrolipoic acid, amino acids, in particular tryptophane, tyrosine, histidine, cysteine, methionine and/or peptides and proteins containing them.

In preferred embodiments of the process one reduces the oxygen content, preferably one removes the oxygen, preferably by means of admixing substances reducing the oxygen content in particular of a solution of the fluorescent dye. Enzymatic systems for reducing or removing the oxygen are preferred, preferred in particular is an enzymatic system comprising glucose oxidase. Preferably the substances reducing the oxygen content are selected from the group comprising glucose oxidase, catalase and/or glucose. The oxygen content can likewise be physically removed for example by throughflow of a solution with nitrogen.

In advantageous manner these substances can reduce the content in oxygen in particular in a solution containing fluorescent dye. In particular the fact that by admixing of the substances reducing oxygen content an additional improvement of the photostability and/or fluorescence intensity of a fluorescent dye can be achieved is of advantage. In particular in the case of cyanines a significant photostability increase was observed by admixture of the substances reducing oxygen content. For example it can also be preferred for very severe excitation conditions such as single molecule fluorescence measurements to add fluorescent dyes for example oxazines to substances reducing the oxygen content measurements.

Preferably in the case of an admixture of substances reducing the oxygen content one admixes additionally dithiothreitol (DTT) and/or Tris-[2-carboxyethyl]-phosphine-hydrochloride (TCEP).

Preferred concentrations lie in the range of ≧10 μg/ml to ≦200 μg/ml, preferably in the range of ≧50 μg/ml to ≦100 μg/ml glucose oxidase, and/or in the range of ≧20 μg/ml to ≦500 μg/ml, preferably in the range of ≧100 μg/ml to ≦200 μg/ml catalase, and/or in the range of ≧5% (w/v) to ≦15% (w/v), preferably in the range of ≧10% (w/v) to ≦22% (w/v) glucose, and/or in the range of ≧0.1 mM to ≦1.2 mM, preferably in the range of ≧0.4 mM to ≦0.8 mM dithiothreitol (DTT).

Fluorescent dyes whose photostabilization can be increased by a redox buffer comprising reducing agents and oxidizing agents or reducing-oxidizing agents are preferably selected from the group comprising fluorescent dyes with a molecular weight of 200 g/mol to 1000 g/mol related to the chromophore.

Preferred fluorescent dyes comprise fluorescent dyes with visually ascertainable fluorescence. In preferred embodiments the fluorescent dyes are selected from the group comprising xanthene dyes, in particular fluorescein, rhodamine and/or carborhodamine, oxazine dyes, rylene, cyanine dyes in particular indolecarbocyanine and/or indoledicarbocyanine, coumarin dyes, pyronine dyes in particular rosamine and/or mixtures thereof.

Preferably redox buffers comprising reducing agents and oxidizing agents for improvement of the photostability of the cationic or anionic forms of the fluorescent dyes can be used.

One special advantage of the inventive redox buffer can be made available by the fact that said redox buffer can bring about a great number of fluorescent dye classes.

In preferred embodiments redox buffers comprising reducing agents and oxidizing agents or reducing-oxidizing agents can be used for improvement of the photostability and/or fluorescence intensity of a fluorescein fluorescent dye in accordance with the following general formula (I)

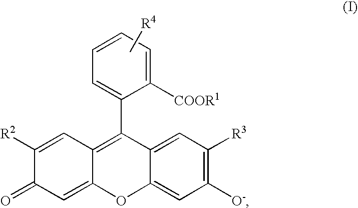

wherein:
R¹ is selected from the group comprising H and/or C₁-C₅ alkyl, preferably H or C₂H₅,
R², R³ are equal or selected independently from one another from the group comprising H, F, Cl, COOH, SO₃H, C₁-C₅-alkyl sulfonic acid and/or C₁-C₅-alkyl carboxylic acid, preferably H, CH₃ and/or C₂H₅,
R⁴ is selected from the group comprising H, COOH and/or COOR¹, preferably H, COOH or COOR¹.

A good improvement of the photostabilization by a redox buffer was achieved for the fluorescein fluorescent dye Oregon Green, wherein in accordance with the formula (I) R¹═H, R²═F, R³═F, and R⁴═COOH. This fluorescein fluorescent dye is preferred in accordance with the invention.

In further preferred embodiments redox buffers comprising reducing agents and oxidizing agents or reducing-oxidizing agents can be used for the improvement of the photostability and/or fluorescence intensity of a rhodamine fluorescent dye in accordance with the following general formula (II)

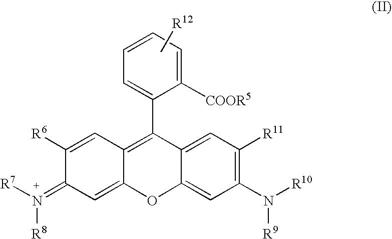

wherein:
R⁵ is selected from a group comprising H and/or C₁-C₅-Alkyl, preferably H and C₂H₅,
R⁷, R⁸, R⁹, R¹⁰ are equal or selected independently from one another from the group comprising H, C₁-C₅-Alkyl, C₁-C₅-alkyl sulfonic acid and/or C₁-C₅-alkyl carboxylic acid, preferably CH₃ and/or C₂H₅,
R⁶, R¹¹ are equal or selected independently from one another from the group comprising H, F, Cl, COOH, SO₃H, C₁-C₅-Alkyl, C₁-C₅-alkyl sulfonic acid and/or C₁-C₅-alkyl carboxylic acid, preferably CH₃ or
   R⁶ forms with R⁷ and/or R¹¹ forms with R¹⁰, if applicable via a group —CH or —CH₂, a ring, preferably an aromatic 5-ring or b-ring,
R¹² is selected from the group comprising H, C₁-C₅-Alkyl, COOH and/or COOR⁵, preferably H, COOH and/or COOR⁵.

An especially good improvement of the photostabilization by redox buffers was achieved for the rhodamine-fluorescent dye RhodamineGreen, wherein in accordance with the formula (II) R⁵═R⁶═R⁸═R⁹═R¹⁰═R¹¹═H, R¹²═COOH. For example an improvement of the photostabilization by redox buffers by a factor 2 was observed. This rhodamine-fluorescent dye is preferred in accordance with the invention.

In especially preferred embodiments redox buffers comprising reducing agents and oxidizing agents or reducing-oxidizing agents can be used for improvement of the photostability and/or fluorescence intensity of a carborhodamine fluorescent dye in accordance with the following general formula (III)

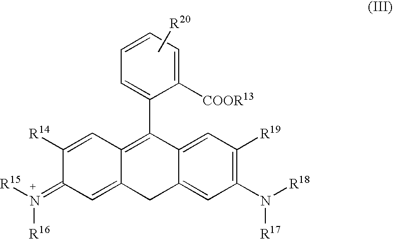

wherein:
R¹³ is selected from the group comprising H and/or C₁-C₅-Alkyl, preferably H and/or C₂—H₅,
R¹⁵, R¹⁶, R¹⁷, R¹⁸ is are equal or selected independently from one another from the group comprising H, C₁-C₅-Alkyl, C₁-C₅-alkyl sulfonic acid and/or C₁-C₅-alkyl carboxylic acid, preferably CH₃ and/or C₂H₅,
R¹⁴, R¹⁹ are equal or selected independently from one another from the group comprising H, F, Cl, COOH, SO₃H, C₁-C₅-Alkyl, C₁-C₅-alkyl sulfonic acid and/or C₁-C₅-alkyl carboxylic acid, preferably CH₃ or
   R¹⁴ forms with R¹⁵ and/or R¹⁹ forms with R¹⁸, if applicable via a group —CH or —CH₂, a ring, preferably an aromatic 5-ring or b-ring,
R²⁰ is selected from the group comprising H, C₁-C₅-Alkyl, COOH and/or COOR¹³, preferably H, COOH and/or COOR¹³.

The photostability of the carborhodamine-fluorescent dye in accordance with the formula (III) was able to be improved especially well through the redox buffer comprising Trolox® as a reducing agent and methylviologen as an oxidizing agent.

In embodiments also especially preferred redox buffers comprising reducing agents and oxidizing agents or reducing-oxidizing agents can be used for improvement of the photostability and/or fluorescence intensity of an oxazine fluorescent dye in accordance with the following general formula (IV)

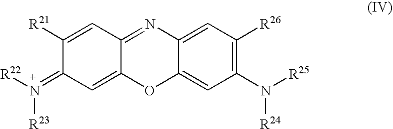

wherein:
R²¹, R²⁶ are equal or selected independently from one another from the alkyl sulfonic acid and/or C₁-C₅-alkyl carboxylic acid, preferably CH₃ or
   R²¹ forms with R²² and/or R²⁶ forms with R²⁵, if applicable via a group —CH or —CH₂, a ring, preferably an aromatic 5-ring or b-ring,
R²², R²³, R²⁴, R²⁵ are equal or selected independently from one another from the group comprising H, C₁-C₅-Alkyl, C₁-C₅-alkyl sulfonic acid and/or C₁-C₅-alkyl carboxylic acid, preferably H, CH₃ and/or C₂H₅.

In embodiments also especially preferred redox buffers comprising reducing agents and oxidizing agents or reducing-oxidizing agents can be used for improvement of the photostability and/or fluorescence intensity of an oxazine fluorescent dye in accordance with the following general formula (V)

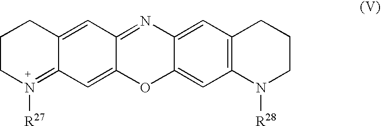

wherein:
R²⁷, R²⁸ are equal or selected independently from one another from the group comprising H, C₁-C₅-Alkyl, C₁-C₅-alkyl sulfonic acid and/or C₁-C₅-alkyl carboxylic acid, preferably (CH₂)₃COOH and/or C₂H₅.

A good improvement of the photostabilization by redox buffers was achieved in particular for oxazine-fluorescent dyes, wherein in accordance with the formula (V) R²⁷═(CH₂)₃COOH, R²⁸═C₂H₅. For example an improvement of the photostabilization by redox buffers by a factor 2 was observed. These oxazine-fluorescent dyes are preferred in accordance with the invention.

In very especially preferred embodiments redox buffers comprising reducing agents and oxidizing agents or reducing-oxidizing agents can be used for improvement of the photostability and/or fluorescence intensity of a cyanine-fluorescent dye in accordance with the following general formula (VI)

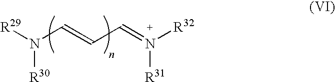

R²⁹, R³⁰, R³¹, R³² are equal or selected independently from one another from the group comprising H, C₁-C₅-Alkyl, C₁-C₅-alkyl sulfonic acid and/or C₁-C₅-alkyl carboxylic acid, preferably (CH₂)₅COOH, CH₃ and/or C₂H₅,
n is 1, 2, 3, 4 or 5, preferably 1 or 2.

In particular indolecarbo-, indoledicarbo- and indoletricarbocyanine-fluorescent dyes based on the indole structure are especially advantageous.

In embodiments also especially preferred redox buffers comprising reducing agents and oxidizing agents or reducing-oxidizing agents can be used for improvement of the photostability and/or fluorescence intensity of an indole cyanine fluorescent dye in accordance with the following general formula (VII)

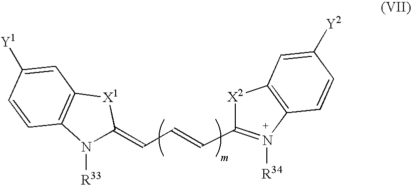

wherein:
R³³, R³⁴ are equal or selected independently from one another from the group comprising H, C₁-C₅-Alkyl, C₁-C₅-alkyl sulfonic acid and/or C₁-C₅-alkyl carboxylic acid, preferably (CH₂)₅COOH, and/or C₂H₅,
X¹, X² are equal or selected independently from one another from the group comprising S, O, CH, CH₂, C(CH₃)₂ and/or S(CH₃)₂,
Y¹, Y² are equal or selected independently from one another from the group comprising H, COOH and/or SO₃H, preferably SO₃H,
m is 1, 2, 3, 4 or 5, preferably 1 or 2.

A good improvement of the photostabilization by redox buffers was achieved in particular for indolecyanin-fluorescent dye Cyanine 3, wherein in accordance with the formula (VII) R³³═R³⁴═C₂H₅, X¹═X²═C(CH₃)₂, Y¹═Y²═SO₃H, SO₃, m=1.

An especially good improvement of the photostabilization by redox buffers was able to be observed in particular for the indole cyanine-fluorescent dye Cyanine 5 in accordance with the following formula (VIII)

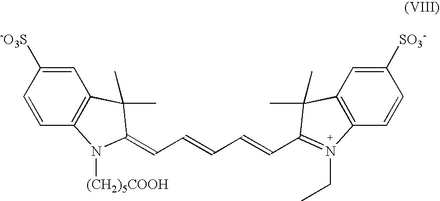

wherein accordingly in accordance with the formula (VII) R³³═(CH₂)₅COOH, R³⁴═C₂H₅, X¹═X²═C(CH₃)₂, Y¹═Y²═SO₃H, SO₃, m=2. These indole cyanine fluorescent dyes are especially preferred in accordance with the invention.

Dicarbocyanine and disulfocyanine-indole cyanine fluorescent dyes are very especially preferred.

In embodiments also especially preferred redox buffers comprising reducing agents and oxidizing agents or reducing-oxidizing agents can be used for improvement of the photostability and/or fluorescence intensity of an indole cyanine fluorescent dye in accordance with the following general formula (IX)

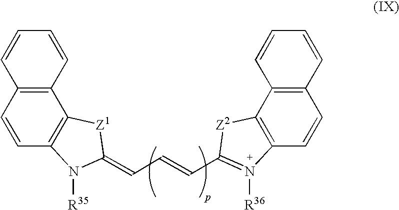

wherein:
R³⁵, R³⁶ are equal or selected independently from one another from the group comprising H, C₁-C₅-Alkyl, C₁-C₅-alkyl sulfonic acid and/or C₁-C₅-alkyl carboxylic acid, preferably (CH₂)₄SO₃H, and/or C₂H₅,
Z¹, Z² are equal or selected independently from one another from the group comprising S, O, CH, CH₂, C(CH₃), C(CH₃)₂ and/or S(CH₃)₂,
p is 1, 2, 3, 4 or 5, preferably 1 or 2.

A good improvement of the photostabilization by redox buffers was able to be observed in particular for the indole cyanine-fluorescent dye Indocyanine Green, wherein in accordance with the formula (IX) R³⁵═R³⁶═(CH₂)₄SO₃H, Z¹, Z²=C(CH₃)₂ p=3.

With reference to the fluorescent dyes in accordance with the formulas (I) through (IX) provision can be made in preferred embodiments that additional aromatic rings can be fused to the fluorescent dye molecules.

In additional preferred embodiments redox buffers comprising reducing agents and oxidizing agents or reducing-oxidizing agents can be used for improvement of the photostability and/or fluorescence intensity of pyronine fluorescent dyes, in particular rosamines.

In embodiments also preferred redox buffers comprising reducing agents and oxidizing agents or reducing-oxidizing agents can be used for improvement of the photostability and/or fluorescence intensity of coumarin fluorescent dyes.

In additional preferred embodiments redox buffers comprising at least one reducing agent and/or at least one oxidizing agent and/or at least one reducing-oxidizing agent can be used for setting the fluorescence state of fluorescein fluorescent dyes in accordance with the general formula (I), rhodamine fluorescent dyes in accordance with the formula (II), carborhodamine fluorescent dyes in accordance with formula (III), oxazine fluorescent dyes in accordance with the formulas (IV) or (V), cyanine fluorescent dyes in accordance with the formulas (VI) and (VIII), indole cyanine fluorescent dyes in accordance with the formulas (VII) and (IX), pyronine fluorescent dyes and/or coumarin fluorescent dyes.

In preferred embodiments the fluorescent dye exhibits a chemical modification and/or is bonded to a biomolecule, wherein the biomolecule is preferably selected from the group comprising proteins, peptides, antibodies and/or nucleic acids.

Preferably the fluorescent dye is functionalized by a chemical modification. For the purpose of this invention the term “functionalized” has the meaning that the fluorescent dye exhibits additional chemical modifications such as functional groups.

In particular water-soluble derivatives are preferable. The water solubility can be improved for example by introduction of hydrophilic or azide groups, preferably by introduction of carboxyl groups and/or sulfonic acid groups into the fluorescent dye molecule. An improvement of the water solubility can also be achieved by glycation, an introduction of saccharides, in particular a glycosylation. In particular preferably are glycated, preferably glycosylated or sulfonated derivatives of fluorescent dyes.

Additionally preferred are chemically activated derivatives of the fluorescent dyes which can mediate a bonding to other molecules through the introduction of a reactive chemical group. Such an activation can take place for example through the introduction of amino, thiol, sulfhydryl and/or carboxyl group. Preferred in particular are derivatives of fluorescent dyes which exhibit amino, thiol, sulfhydryl and/or carboxyl groups.

Preferably chemical groups mediating a covalent bonding to molecules in particular biomolecules are selected from the group comprising maleic acid imides, N-Hydroxy-succinimide and/or N-Hydroxy-succinimide esters, in particular methyl-, ethyl- and/or propylesters, N-Hydroxy-phthalimide, and/or N-Hydroxy-phthalimide esters, in particular Methyl-, Ethyl- and/or Propylester.

These chemical groups make it possible to bond fluorescent dyes covalently to organic, inorganic, natural or synthetic molecules, in particular biomolecules, or to polymers. In particular N-Hydroxy-succinimide and N-Hydroxy-phthalimide can make available the advantage that these can form a covalent bond between the fluorescent dye and the biomolecule, wherein the group is split off. Preferably covalent bonds to peptides and proteins can be formed.

Preferred in particular are N-Hydroxy-succinimide esters of the fluorescent dyes, biotinylated fluorescent dyes or Maleic acid imides of the fluorescent dyes, in particular N-Hydroxy-succinimide esters of the indole cyanine fluorescent dyes. Very especially preferred are N-Hydroxy-succinimide esters of the dicarbocyanine indole cyanine fluorescent dyes, for example dicarbocyanine-5,5′-disulfonatkaliumsalz-N-hydroxysuccinimdester (Cy5).

The fluorescent dye can additionally exhibit reactive groups selected from the group comprising Isothiocyanate, isocyanate, monochlortriazine, dichlortriazine, aziridine, sulfon halogenide, imido esters, glyoxal or aldehyde and hydroxyl functions, iodacetamide functions and/or phosphoramidite for the purpose of mediating of a bond to additional molecules.

Additionally preferably the fluorescent dye can be biotinylated or farnelyzated.

The fluorescent dye can be bonded to natural or synthetic molecules, for example biodegradable polymers, in particular to biomolecules.

For the purpose of the present invention biomolecules are to be understood in particular as proteins, peptides, oligomers, nucleic acids in particular DNA and/or RNA, antibodies, small organic molecules with biological effect, carbohydrates, fats, pharmaceuticals or also cells, wherein the biomolecule is preferably selected from the group comprising proteins, peptides, antibodies and/or nucleic acids.

A bonding of the fluorescent dye in particular with biomolecules can for example be based on a covalent or non-covalent interaction, conjugation, adsorption, association or another type of bonding. Preferably the fluorescent dye is bonded to a biomolecule via a covalent bond. The fluorescent dye preferably forms a conjugate with DNA or antibodies.

Biomolecules marked with fluorescent dyes can be used in many cases in analytical and diagnostic methods in biochemistry and medicine, in particular in molecular-biological assays and in medical diagnostics. The quantity or intensity of a fluorescent signal can for example make the presence and/or quantity of a biomolecule determinable.

In advantageous manner fluorescent dyes can be conjugated in particular to antibodies and can be used for example in flow cytometry. Fluorescent dyes bonded to antibodies can be additionally used as fluorescent probes for specific marking in immunology. In particular fluorescein and rhodamine fluorescent dyes are suitable for being conjugated to antibodies. The fluorescent dye can also be bonded to carriers for fluorescent dyes, for example to colloidal polymer particles or nanoparticles, for example for an application of the fluorescent dye in human beings through intravenous or oral administration.

Fluorescent dyes can additionally be used as markers in order to mark biological substances, such as proteins, peptides or DNA. Fluorescent dyes bonded to nucleic acids are employed for example in nucleic acid assays, in the case of the automatic sequencing of DNA or RNA, or for the detection of nucleic acids for example in gene chips or DNA arrays. Fluorescent dyes bonded to proteins, peptides or oligomers are employed for example for detection on protein chips.

Fluorescent dyes can in addition for example be so-called calcium dyes or indicator dyes, which can be used for the detection of organic or inorganic molecules or biomolecules.

An additional subject matter of the invention relates to the use of an inventive redox buffer comprising at least one reducing agent and at least one oxidizing agent or a reducing-oxidizing agent for improving the photostability and/or fluorescence intensity of a fluorescent dye.

It is of particular advantage that the use of an inventive redox buffer for example in molecular-biological assays and in medical diagnostics through the improvement of the photostability of the fluorescent dye made available can make an extension of the measuring time available. Measurements over longer time periods make possible in particular a tracing of time-dependent procedures, in particular biological procedures involving fluorescent marked biomolecules. In addition an employment of an inventive redox buffer can increase the measuring sensitivity made available through the improvement of the fluorescence intensity of the fluorescent dye. This makes possible more precise, higher resolution measurements.

In particular it is of advantage that the fastness of samples for example of biological samples marked with fluorescent dye can be extended. This makes it possible for example to measure said biological samples again at a later date.

One very special advantage can be made available as a result of the fact that lower doses of the fluorescent dyes can be used as markers. This is in particular of advantage since fluorescent dyes can under circumstances interfere with biological functions or be toxic.

An additional subject matter of the invention relates to the use of redox buffers comprising at least one reducing agent, and/or at least one oxidizing agent and/or at least one reducing-oxidizing agent for setting the fluorescent state of fluorescent dyes.

The use of redox buffers comprising reducing agents and/or oxidizing agents for setting the fluorescent state of fluorescent dyes in particular for controlled setting of the “Off” and “On” times of fluorescent dyes has great advantages. Thus the synthesis and provision of optically switchable dyes is nowadays considered as a key area of the future fluorescence microscopy. In advantageous manner through the use of inventive redox buffers comprising reducing agents and/or oxidizing agents opens up the possibility of using a variety of organic dyes for high resolution fluorescence microscopy below the diffraction limit with the help of localization microscopy, for example STORM (stochastic optical reconstruction microscopy), PALM (photoactivated localization microscopy) or FPALM (fluorescence photoactivated localization microscopy) microscopy or also for DSOM (dynamic saturation optical microscopy) microscopy.

In particular redox buffers comprising at least one reducing agent, and/or at least one oxidizing agent and/or at least one reducing-oxidizing agent can be used for increasing the optical resolution of imaging fluorescence microscopy processes.

An additional subject matter of the invention relates to a fluorescent dye composition containing a fluorescent dye and a redox buffer comprising at least one reducing agent, and/or at least one oxidizing agent and/or at least one reducing-oxidizing agent.

Yet another subject matter relates to a photostabilized fluorescent dye composition containing a fluorescent dye and an inventive redox buffer comprising at least one reducing agent and at least one oxidizing agent or one reducing-oxidizing agent.

Photostabilized fluorescent dye compositions containing a fluorescent dye and an inventive redox buffer comprising at least one reducing agent and at least one oxidizing agent or one reducing-oxidizing agent can be used for example in molecular-biological assays and in medical diagnostics. Inventive fluorescent dye compositions can be especially photostable through the effect of the inventive redox buffer and/or can make available increased fluorescence intensity. Reference is made in its entirety to the foregoing description for the description of suitable fluorescent dyes and suitable redox buffers.

The fluorescent dye compositions contain one or more fluorescent dyes and redox buffers comprising at least one reducing agent and at least one oxidizing agent or at least one reducing-oxidizing agent in aqueous or organic solvents, preferably in an aqueous solvent, especially preferably in water. In aqueous solvents suitable redox buffers are especially readily soluble, in addition aqueous solvents are used frequently in fluorescence assays.

In addition photostabilized fluorescent dye compositions can be used especially advantageously in the case of in vitro fluorescence microscopy and fluorescence measurements of biomolecules or biological samples.

In accordance with the invention photostabilized fluorescent dye compositions and their usage are preferred in which case the concentration of the redox buffer lies in the range of ≧0.2 mM to ≦10 mM, preferably in the range of ≧1 mM to ≦5 mM, especially preferably in the range of ≧2 mM to ≦3 mM. These concentrations are especially preferred when the dye product contains the fluorescent dye or dyes and the redox buffer in an aqueous solvent, in particular in water. In addition photostabilized fluorescent dye compositions and their are preferred in which case the concentration of the redox buffer lies in the range of ≧100 pM to ≦100 μM, preferably in the range of ≧1 μM to ≦10 μM, especially preferably in the range of ≧2 μM to ≦5 μM.

In preferred embodiments the fluorescent dye composition, in particular the photostabilized fluorescent dye composition comprises the substances reducing the oxygen content preferably selected from the group comprising glucose oxidase, catalase and/or glucose. Reference is made in its entirety to the foregoing description for the description of suitable substances reducing the oxygen content.

Photostabilized fluorescent dye compositions containing a fluorescent dye and an inventive redox buffer comprising at least one reducing agent and at least one oxidizing agent or one reducing-oxidizing agent can be used in additional preferred embodiments in photograph, where they can be employed as sensitizing agents, or in organic dye lasers. For example photostabilized fluorescent dye compositions can be used for dye lasers or as a reference solution for microscopic and spectroscopic purposes.

In particular photostabilized fluorescent dye compositions can be used in fluorescence microscopy. Further application possibilities lie in the field of confocal fluorescence microscopy. In the case of confocal fluorescence microscopy the photostability of fluorescent dyes is of particular significance due to the high laser light intensities. Through confocal fluorescence microscopy in particular biological samples marked with fluorescent dyes can be analyzed, wherein the admixture of a photostabilizing redox buffer can extend the time during which the biological samples marked with a fluorescent dye can be examined.

In addition inventive photostabilized fluorescent dye compositions can be used in the field of active ingredient research, in high throughput screening, wherein an increased photostability can be used in particular in the case of the use of focused laser lights.

In addition inventive photostabilized fluorescent dye compositions can be used preferably as reference solutions for calibration and optimization, in which case a high photostability of a standard solution of a fluorescent dye can provide the advantage of increased reliability and increased reproducibility of the measuring results.

The use of photostabilized fluorescent dye compositions in single molecule spectroscopy is of particular advantage. In particular in single molecule spectroscopy it is of great advantage that an improvement of the photostability of a fluorescent dye permits a longer observation of a single molecule through a redox buffer. In addition an improvement of the fluorescence intensity of a fluorescent dye is of tremendous advantage in the observation of single molecules, thus single fluorescence signals. Additionally of great advantage in a usage of the inventive redox buffers in single molecule spectroscopy is the fact that inventive redox buffers can reduce intensity fluctuations, the “blinking”. This provides the great advantage that single molecules can be observed without greater interruption of their fluorescence.

An additional subject matter of the invention is a kit which is suitable for the carrying out of the process for improving the photostability and/or fluorescence intensity of a fluorescent dye. The kit contains at least one fluorescent dye and one redox buffer comprising at least one reducing agent and at least one oxidizing agent or at least one reducing-oxidizing agent.

In preferred embodiments the kit contains at least one reagent comprising a fluorescent dye and at least one reagent comprising a redox buffer comprising at least one reducing agent and at least one oxidizing agent or at least one reducing-oxidizing agent. The kit can also comprise a reagent comprising a fluorescent dye and several, for example two reagents comprising each at least one reducing agent and at least one oxidizing agent, which form a redox buffer after mixing. Further the kit can contain substances reducing the oxygen content, preferably selected from the group comprising glucose oxidase, catalase and/or glucose. The kit can additionally comprise an inventive photostabilized fluorescent dye composition.

Provision can also be made that the kit contains a reagent which comprises at least one fluorescent dye which exhibits a chemical modification and/or is bonded to a biomolecule, wherein the biomolecule is preferably selected from the group comprising proteins, peptides, antibodies and/or nucleic acids. The kit can additionally contain buffers and/or solvents which are required for the carrying out of the process. Provision can also be made that the kit comprises a detection unit.

Yet another subject matter of the invention is a kit which is suitable for the carrying out of the process for setting the fluorescence state of a fluorescent dye. The kit contains at least one fluorescent dye and one redox buffer comprising at least one reducing agent, and/or at least one oxidizing agent and/or at least one reducing-oxidizing agent.

Unless otherwise stated, the technical and scientific expressions employed exhibit the meaning as they are understood generally by a person having average skill in the art in the field to which this invention belongs.

All publications, patent applications, patents and further references specified here are incorporated in their entire contents through by reference.

Examples and figures which serve the purpose of illustration of the present invention are cited in the following.

### THE FIGURES SHOW THE FOLLOWING

FIG. 1a shows the increase of the photostability of the cyanine fluorescent dye Cy5 by the oxidizing agent methylviologen,

FIG. 1b shows the increase of the photostability of the cyanine fluorescent dye Cy5 by the reducing agent Trolox®,

FIG. 1c shows the increase of the photostability of the cyanine fluorescent dye Cy5 by the inventive redox buffer, in each case determined by single molecule fluorescence measurement of the fluorescent dye coupled to DNA.

### EXAMPLE 1

The single molecule fluorescence measurement of a cyanine fluorescent dye coupled to DNA, wherein the immobilization of the DNA and the single molecule measurements took place as described in “Heilemann, m.; Kasper, R.; Tinnefeld, P.; Sauer, M. J Am Chem Soc 2006, 128, 16864-16875” and “Tinnefeld, P.; Buschmann, V.; Weston, K. D.; Biebricher, A.; Herten, D.-P.; Piestert, O.; Heinlein, T.; Heilemann, M.; Sauer, M. Rec. Res. Dev. Phys. Chem. 2004, 7, 95-125”, when not specified in deviation in the following.

Biotinylated single-stranded oligonnucleotides (60 bases, 5′-ATC GTT ACC AAA GCA TCG TAA ATC GCA TAA TAG CAC GTT AAT TTA GCA CGG ACG ATC GCC-3′-biotin, SEQ ID No 1, IBA, Gottingen) were marked by means of standard NHS ester chemistry with the N-hydroxy succinimide ester (NHS ester) of the cyanine fluorescent dye Cy5 (Amersham Biosciences Europe, Freiburg). For this purpose a quintuple surplus of 50 nMol NHS ester of the cyanine fluorescent dye Cy5 was admixed to 10 nMol of the oligonnucleotide dissolved in 0.1 M carbonate buffer (pH=9.4, carbonate buffer, Merck, Darmstadt) and incubated for 6 hours in darkness.

The marked oligonnucleotides were then cleaned up by means of HPLC (Hewlett Packard, Böblingen) via a reversed-phase column (Knauer, Berlin) packed with octadecylsilane hypersil C18. The separation took place in 0.1 M triethyl ammonium acetate, using a linear gradient of 0% to 75% acetonitrile for 20 minutes. The yield was circa 85%.

The single-stranded oligonucleotides which contain the cyanine fluorescent dye Cy5 at the 5′ end and a biotin linker on the 3′ end were then hybridized with the complementary DNA strand (IBA, Göttingen). After a brief heating up to 95° C. the sample was cooled within a minute to 65° C. and then further cooled slowly within two hours to 4° C. The double-stranded DNA was then immobilized from a 10 nanomolar solution in streptavidin-coated glass surfaces as described in “Heilemann, M.; Kasper, R.; Tinnefeld, P.; Sauer, M. J Am Chem Soc 2006, 128, 16864-16875”.

Finally a solution of the redox buffer containing 0.5 mM of the oxidizing agent methylviologen and 1.8 mM of the reducing agent Trolox® as well as oxygen-removing enzymes were added to the cyanine fluorescent dye immobilized to DNA. This solution was produced by adding 940 μl solution of a solution containing the reducing agent as well as substrates for the oxygen-removing enzymes, 10% (wt./vol.) glucose (Sigma-Aldrich, Germany), 12.5% (vol/vol) glycerol (Sigma-Aldrich, Germany), 2.5 mM 6-hydroxy-2,5,7,8-Tetramethylchromane-2-carboxylic acid (Trolox®, Sigma-Aldrich, Germany) to PBS (pH 7.4, Sigma-Aldrich, Germany). 1 μl of a 1 mol/l-solution of methylviologen (Sigma-Aldrich, Germany) in PBS was added to this solution. Then 60 μl of a solution containing the oxygen-removing enzymes, 50-100 μg/ml glucose oxidase (Sigma-Aldrich, Germany), 100-200 μg/ml catalase (Sigma-Aldrich, Germany), 0.4-0.8 mmol/l TCEP (Tris[2-carboxyethyl]phosphine hydrochloride, Sigma-Aldrich, Germany) were added to PBS. The sample was immediately hermetically sealed after addition of the solution.

In parallel measurements corresponding solutions containing 1 mM of the oxidizing agent methylviologen or 1.8 mM of the reducing agent Trolox® were used.

The single molecule fluorescence measurements were carried out as described in particular in “Tinnefeld, P.; Buschmann, V.; Weston, K. D.; Biebricher, A.; Herten, D.-P.; Piestert, O.; Heinlein, T.; Heilemann, M.; Sauer, M. Rec. Res. Dev. Phys. Chem. 2004, 7, 95-125”. The laser beam of a 635 nm-diode laser (PicoQuant, Germany) was coupled with an oil immersion objective (100×, NA 1.45; Zeiss) by means of a dichroic beam splitter (650 DRLP, AHF Analysentechnik, Germany). The fluorescence was collected by the same objective and spatially filtered through a 100 μm pinhole diaphragm on the focal plane of the microscope (Axiovert 200 M, Zeiss). The fluorescence signal was split up by a dichroic beam splitter (680 DRLP) into two detection channels and made visible on the active surface of two avalanche photodiodes (APD; AQR-14; EG&G, Canada).

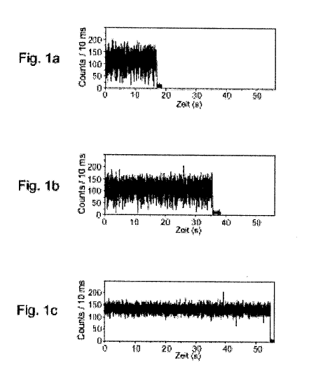

As shown in FIG. 1a, it was able to be observed that an addition of 1 mM of the oxidizing agent methylviologen alone brings about a lifespan of the fluorescence of about more than 15 seconds. FIG. 1b shows that an addition of 1.8 mM of the reducing agent Trolox® alone brings about a lifespan of the fluorescence of circa 35 seconds.

FIG. 1c shows that an addition of the redox buffer containing 1.8 mM of the reducing agent Trolox® and 0.5 mM of the oxidizing agent methylviologen generated a lifespan of the fluorescence of almost 55 seconds. The photostability was able to be significantly increased in comparison with a usage of reducing agents or oxidizing agents alone. From the essentially narrower bandwidth of the measurement it further arises that the intensity fluctuations were significantly reduced.

### EXAMPLE 2

### Single Molecule Fluorescence Measurement of a Carborhodamine Fluorescent Dye Immobilized to DNA

The determination took place as described under Example 1, wherein the carborhodamine fluorescent dye ATTO647N (ATTO-TEC, Siegen) was used.

It was able to be observed that an addition of 1 mM of the oxidizing agent methylviologen alone brings about a lifespan of about more than 20 seconds, while an addition of 1.8 mM of the reducing agent Trolox® alone brings about a lifespan of the fluorescence of circa 70 seconds.

By way of contrast an addition of the redox buffer containing 1.8 mM of the reducing agent Trolox® and 0.5 mM of the oxidizing agent methylviologen produced a lifespan of the fluorescence of almost 20 minutes.

The photostability was able to be very significantly increased in comparison with a usage of reducing agents or oxidizing agents alone.

### EXAMPLE 3

### Measurements of the Photostability of a Cyanine Fluorescent Dye in Solution

The measurement took place in solution containing a redox buffer comprising as reducing agent 3 mM Trolox® and as oxidation agent 3 mM methylviologen. The measurement took place without the addition of oxygen-removing enzymes.

A corresponding solution was produced by adding 940 μl of a solution containing 3 mM 6-Hydroxy-2,5,7,8-tetramethylchromane-2-carboxylic acid (Trolox®, Sigma-Aldrich) in PBS (pH 7.4, Sigma-Aldrich) in a sealable quartz cuvette. 1 μl of a 3M solution of methylviologen (Sigma-Aldrich) in PBS was added to this solution. Then 0.1 μm of the cyanine fluorescent dye Cy5 (Amersham Biosciences Europe, Freiburg) was added. The cuvette was immediately hermetically sealed after the addition of the solution.

In parallel measurements corresponding solutions containing 3 mM of the oxidizing agent methylviologen or 3 mM of the reducing agent Trolox® as well as a solution containing only 0.1 μM of the cyanine fluorescent dye Cy5 were used.

The measurement of the fluorescence took place in the case of an excitation with wavelengths of 488 nm or 647 nm with an Ar—Kr laser (Spectra-Physics, Germany). The distance of the cuvette was 10 mm.

It was able to be observed that the redox buffer used achieved a circa 2.6 times improvement of the photostability in comparison with the solution of the fluorescent dye in PBS, while the reducing agent by itself caused a circa 1.6 times improvement of the photostability.

This shows that a usage of the redox buffer can achieve a significant improvement of the photostability in the presence of oxygen.

### EXAMPLE 4

The length of the dark state of a cyanine fluorescent dye coupled to DNA in a single molecule fluorescence measurement.

In this connection the immobilization of the DNA took place as described under Example 1, wherein in deviation the double-stranded DNA containing the cyanine fluorescent dye cy5 (GE Healthcare) on the 5′ end and a biotin linker on the 3′ end was immobilized from a 10 nanomolar solution streptavidin (Roche)-coated glass surfaces inhibited with BSA (Bovine Serum Albumin) as described in “Heilemann, M.; Kasper, R.; Tinnefeld, P.; Sauer, M. J Am Chem Soc 2006, 128, 16864-16875”.

Then 400 μl of a solution containing oxygen-removing enzymes, containing 50-100 μg/ml glucose oxidase (Sigma-Aldrich, Germany), 100-200 μg/ml catalase (Sigma-Aldrich, Germany), 10% (wt/vol) glucose (Sigma-Aldrich, Germany) and 0.1 mM Tris(2-carboxyethyl)phosphine-hydrochloride in PBS were added to the cyanine fluorescent dye immobilized to DNA. Then 1 μl of a solution of the redox buffer for a 1 mM deconcentration of the reducing agent ascorbic acid was added to this solution. The sample was immediately hermetically sealed after the addition of the solutions.

By means of the addition of 1 mM of the reducing agent ascorbic acid the duration of the non-fluorescing “Off” state of the fluorescent dye Cy5 of circa 55 ms was purposefully set.

The single molecule fluorescence measurement was carried out with total internal reflection on an inverse fluorescence microscope (Olympus, Objective NA 1.49). The sample was excited with 100 mW via an Ar⁺Kr⁺Laser (Spectra Physics) at 647 nm over total internal reflection. The detection took place with the help of an EMCCD (electron multiplying CCD) detector (Andor IXon+DU 897). In the process 200 to 1000 frames were photographed in frame transfer mode at an integration time of 8 ms. One pixel corresponded to 75 nm×75 nm.

The data of the camera were evaluated with the help of a self-developed LabView routine. In the process in each image of the film all the active emitting molecules active at this time were found via an efficient image evaluation (point recognition). In this connection both the shape of the points, their brightness as well as also the quality of the positioning adjustment were used in order to rule out any double collision events, that two dye molecules are simultaneously active. The position of each molecule in each image was determined via a two-dimensional GauB adjustment. These positions were then histogrammed in a matrix with 15 nm×15 nm resolution and in this way reconstructed into high resolution images.

A reconstructed averaged image from the single molecule localization over the entire film with 15 nm/pixel showed clearly that the molecules appear separated from one another.

In a corresponding comparative test without the addition of a solution of the redox buffer containing 1 mM of the reducing agent ascorbic acid the duration of the non-fluorescing “Off” state of the fluorescent dye Cy5 was circa 5 ms.

A corresponding conventional wide field fluorescence image showed clearly that the molecules with conventional microscopy resulted in irresolvable images.

1. A process for improving the photostability and/or control of the fluorescence intensity of a fluorescent dye, characterized in that a fluorescent dye is admixed with a redox buffer comprising at least one reducing agent and/or at least one oxidizing agent and/or at least one reducing-oxidizing agent.

2. The process for improving the photostability and/or control of the fluorescence intensity of a fluorescent dye according to claim 1, characterized in that a fluorescent dye is admixed with a redox buffer comprising at least one reducing agent and at least one oxidizing agent or at least one reducing-oxidizing agent.

3. The process according to claim 1, characterized in that the oxidizing means of the redox buffer is selected from a group comprising bipyridinium salts, preferably viologens, in particular methylviologen, nitroaromatics, in particular carboxylic acid substituted nitroaromatics or sulfonic acid substituted nitroaromatics, preferably nitrobenzene, benzoquinone, substituted benzoquinone, in particular chlorine substituted and/or cyan substituted benzoquinone, in particular dichlorobenzoquinone, tetrachlorobenzoquinone, and or mixtures thereof.

4. The process according to claim 1, characterized in that the reducing agent of the redox buffer is selected from the group comprising from the group comprising 6-Hydroxy-2,5,7,8-tetramethylchromane-2-carboxylic acid, ascorbic acid, β-mercaptoethanol, β-mercaptoethylamine, β-Napthylamine, Dithiothreitol, NaBH₃CN, n-Propyl-Gallate and/or mixtures thereof.

5. The process according to claim 1, characterized in that the ratio of reducing agent to oxidizing agent lies in the range of ≧1000:0 to ≦0:1000, preferably in the range of ≧100:1 to ≦0:100, especially preferably in the range of ≧10:1 to ≦1:10.

6. The process according to claim 1, characterized in that the ratio of reducing agent to oxidizing agent lies in the range of ≧1:3 to ≦10:1, preferably in the range of ≧1:2 to ≦4:1, preferably in the range of ≧1:1 to ≦2:1.

7. The process according to claim 1, characterized in that one reduces the oxygen content, preferably by means of admixing substances reducing the oxygen content selected from the group comprising glucose oxidase, catalase and/or glucose.

8. The process according to claim 1, characterized in that the fluorescent dyes are selected from the group comprising xanthene dyes, in particular fluorescein, rhodamine and/or carborhodamine, oxazine dyes, rylene, cyanine dyes in particular indolecarbocyanine and/or indoledicarbocyanine, coumarin dyes, pyronine dyes in particular rosamine and/or mixtures thereof.

9. The process according to claim 1, characterized in that the fluorescent dye exhibits a chemical modification and/or is bonded to a biomolecule, wherein the biomolecule is preferably selected from the group comprising proteins, peptides, antibodies and/or nucleic acids.

10. The use of a redox buffer according to claim 1 for improving the photostability and/or control of the fluorescence intensity of a fluorescent dye.

11. The use of a redox buffer comprising at least one reducing agent and/or at least one oxidizing agent and/or at least one reducing-oxidizing agent for setting the fluorescence state of a fluorescent dye.

12. Photostabilized fluorescent dye composition containing a fluorescent dye and a redox buffer comprising at least one reducing agent and at least one oxidation agent or at least one reducing-oxidizing agent according to claim 1.

13. Photostabilized fluorescent dye composition according to claim 12, characterized in that the fluorescent dye composition comprises substances reducing the oxygen content preferably selected from the group comprising glucose oxidase, catalase and/or glucose.

14. Fluorescent dye composition containing a fluorescent dye and a redox buffer comprising at least one reducing agent and/or at least one oxidizing agent and/or at least one reducing-oxidizing agent, wherein the fluorescent dye composition can comprise substances reducing the oxygen content preferably selected from the group comprising glucose oxidase, catalase and/or glucose.

15. A kit for improving the photostability and/or fluorescence intensity of a fluorescent dye, characterized in that the kit contains at least a fluorescent dye and a redox buffer comprising at least one reducing agent and at least one oxidizing agent or at least one reducing-oxidizing agent in accordance with claim 1.

16. The process according to claim 2, characterized in that the oxidizing means of the redox buffer is selected from a group comprising bipyridinium salts, preferably viologens, in particular methylviologen, nitroaromatics, in particular carboxylic acid substituted nitroaromatics or sulfonic acid substituted nitroaromatics, preferably nitrobenzene, benzoquinone, substituted benzoquinone, in particular chlorine substituted and/or cyan substituted benzoquinone, in particular dichlorobenzoquinone, tetrachlorobenzoquinone, and or mixtures thereof.

17. The process according to claim 2, characterized in that the reducing agent of the redox buffer is selected from the group comprising from the group comprising 6-Hydroxy-2,5,7,8-tetramethylchromane-2-carboxylic acid, ascorbic acid, β-mercaptoethanol, β-mercaptoethylamine, β-Napthylamine, Dithiothreitol, NaBH₃CN, n-Propyl-Gallate and/or mixtures thereof.

18. The process according to claim 3, characterized in that the reducing agent of the redox buffer is selected from the group comprising from the group comprising 6-Hydroxy-2,5,7,8-tetramethylchromane-2-carboxylic acid, ascorbic acid, β-mercaptoethanol, β-mercaptoethylamine, β-Napthylamine, Dithiothreitol, NaBH₃CN, n-Propyl-Gallate and/or mixtures thereof.

19. The process according to claim 16, characterized in that the reducing agent of the redox buffer is selected from the group comprising from the group comprising 6-Hydroxy-2,5,7,8-tetramethylchromane-2-carboxylic acid, ascorbic acid, β-mercaptoethanol, β-mercaptoethylamine, β-Napthylamine, Dithiothreitol, NaBH₃CN, n-Propyl-Gallate and/or mixtures thereof.

20. The process according to claim 2, characterized in that the ratio of reducing agent to oxidizing agent lies in the range of ≧1000:0 to ≦0:1000, preferably in the range of ≧100:1 to ≦0:100, especially preferably in the range of ≧10:1 to ≦1:10.
